(19) United States
(12) Patent Application Publication
(10) Pub. No.: US 2019/0080093 A1
(43) Pub. Date: Mar. 14, 2019

(54) SECURE SELECTIVE LOAD OF DYNAMIC PAGED SEGMENTS IN MEMORY CONSTRAINED SYSTEMS

(71) Applicant: QUALCOMM Incorporated, San Diego, CA (US)

(72) Inventors: Eugen PIRVU, Mission Viejo, CA (US); Dhamim PACKER ALI, San Diego, CA (US); Dhaval Patel, San Diego, CA (US); Bhargav GURAPPADI, San Diego, CA (US)

(21) Appl. No.: 15/702,628

(22) Filed: Sep. 12, 2017

(51) Int. Cl. G06F 21/57; G06F 9/44; H04L 9/06; H04L 9/32

(52) U.S. Cl. CPC G06F 21/575; H04L 9/3242; H04L 9/0643; G06F 9/4406

(57) ABSTRACT

Techniques for the secure loading of dynamic paged segments are provided. An example method according to the disclosure includes determining a first hash value for each of one or more pageable segments associated with a device, authenticating the one or more pageable segments based on the first hash values, determining a second hash value for each of the one or more pageable segments, transferring the second hash values for each of the pageable segments to the device, determining a load hash value for a loading pageable segment when the loading pageable segment is to be loaded into the device, comparing the load hash value with the second hash value associated with the loading pageable segment, and loading the loading pageable segment in the device when the load hash value matches the second hash value associated with the loading pageable segment.

### BACKGROUND

The following description relates generally to multiprocessor systems, and more specifically to multiprocessor systems in which a processor is coupled to a nonvolatile memory storing executable software images(s) that may exceed the memory capacity of the processor.

Processors execute software code to perform operations. Processors may use particular software code, commonly referred to as boot code, to be executed for booting up. In a multi-processor system, each processor may use respective boot code for booting up. As an example, in a smartphone device that includes an application processor and a modem processor, each of the processors may use respective boot code for booting up.

In some multi-processor systems, software may be loaded to one processor from another processor. For example, a first processor in a multi-processor system may be responsible for storing to its non-volatile memory boot code for one or more other processors in the system such that upon power-up or reset the first processor is tasked with loading the respective boot code to the other processor(s), as opposed to such boot code residing in non-volatile memory of the other processor(s). In this type of system, the software (e.g., boot image) is downloaded from the first processor to the other processor(s) (e.g., to volatile memory of the other processor(s)), and thereafter the receiving processor(s) boots with the downloaded image. In some examples, the size of the boot code may exceed the memory available to the receiving processor(s). In this case, boot code may be provided in pageable segments with each page being provided when needed by the receiving processor. The pageable segments may then be ejected from memory after being executed (i.e., when they are no longer needed by the receiving processor(s)).

The security and reliability of an operating system within multiprocessor data processing devices is an increasingly important concern. The validity of boot code, and the corresponding pageable segments, from one processor must be verified when it is loaded on another processor to ensure the boot process has not been corrupted by malicious code. The process cycles and associated time required to authenticate each of the pageable segments may prolong the total time required to execute a boot process.

### SUMMARY

An example method for loading pageable segments in a device according to the disclosure includes determining a first hash value for each of one or more pageable segments associated with the device, authenticating the one or more pageable segments based on the first hash values, determining a second hash value for each of the one or more pageable segments, transferring the second hash values for each of the pageable segments to the device, determining a load hash value for a loading pageable segment when the loading pageable segment is to be loaded into the device, such that the loading pageable segment is one of the one or more pageable segments, comparing the load hash value with the second hash value associated with the loading pageable segment, and loading the loading pageable segment in the device when the load hash value matches the second hash value associated with the loading pageable segment.

Implementations of such a method may include one or more of the following features. The second hash value and the load hash value may be lightweight hash values. The second hash value and the load hash value may be Toeplitz hash values. The second hash value and the load hash value may be determined by a software algorithm and/or a hardware element. The pageable segments may be in an executable and linkable format (ELF). The first hash values for the one or more pageable segments may be based on an Elliptic Curve Cryptography (ECC) algorithm. Transferring the second hash values for each of the pageable segments to the device may include storing the second hash values in a memory device disposed on the device. A random key may be used to compute the second hash value and the load hash value. The one or more pageable segments may persist in a flash memory device.

An example device according to the disclosure includes a memory, at least one processor operable coupled to the memory and configured to determine a first hash value for each of one or more pageable segments associated with the device, authenticate the one or more pageable segments based on the first hash values, determine a second hash value for each of the pageable segments, store the second hash values for each of the pageable segments in the memory, determine a load hash value for a loading pageable segment when the loading pageable segment is to be loaded into the device, such that the loading pageable segment is one of the one or more pageable segments, compare the load hash value with the second hash value associated with the loading pageable segment, and load the loading pageable segment when the load hash value matches the second hash value associated with the loading pageable segment.

Implementations of such a device may include one or more of the following features. The at least one processor may be operably coupled to an application processor. The one or more pageable segments may be received from the application processor. The at least one processor may be operably coupled to a flash memory device. The one or more pageable segments may be received from the flash memory device. The pageable segments may be in an executable and linkable format (ELF). The at least one processor may be configured to the first hash values for each of the one or more pageable segments based on an Elliptic Curve Cryptography (ECC) algorithm. The at least one processor may be configured to determine a random key and the second hash value and the load hash value are based at least in part on the random key. The second hash value and the load hash value may be lightweight hash values. The second hash value and the load hash value may be Toeplitz hash values.

An example of a device according to the disclosure includes means for determining a first hash value for each of one or more pageable segments associated with the device, means for authenticating the one or more pageable segments based on the first hash values, means for determining a second hash value for each of the one or more pageable segments, means for transferring the second hash values for each of the pageable segments to the device, means for determining a load hash value for a loading pageable segment when the loading pageable segment is to be loaded into the device, such that the loading pageable segment is one of the one or more pageable segments, means for comparing the load hash value with the second hash value associated with the loading pageable segment, and means for loading the loading pageable segment in the device when the load hash value matches the second hash value associated with the loading pageable segment.

An example of a non-transitory processor-readable storage medium comprising processor-readable instructions configured to cause one or more processors to load pageable segments in a device according to the disclosure, includes code for determining a first hash value for each of one or more pageable segments associated with the device, code for authenticating the one or more pageable segments based on the first hash values, code for determining a second hash value for each of the one or more pageable segments, code for transferring the second hash values for each of the pageable segments to the device, code for determining a load hash value for a loading pageable segment when the loading pageable segment is to be loaded into the device, such that the loading pageable segment is one of the one or more pageable segments, code for comparing the load hash value with the second hash value associated with the loading pageable segment, and code for loading the loading pageable segment in the device when the load hash value matches the second hash value associated with the loading pageable segment.

Items and/or techniques described herein may provide one or more of the following capabilities and/or possibly one or more other capabilities not mentioned. An Internet of Things (IoT) device may be operationally coupled to an application processor and/or a memory device. The IoT device may be a System on Chip (SoC) configured to provide higher end functionalities. A boot process flow may authenticate and load resident and pageable segments from the application processor or memory device. A lightweight hash value may be computed and stored for each of the pageable segments. A firmware image on the IoT device may evict and load the pageable segments as needed based on available memory. A pageable segment may be validated based on the lightweight hash value. Boot load time may be improved. The performance of the IoT device may be improved. Power consumption by the IoT device may be reduced. Further, it may be possible for an effect noted above to be achieved by means other than they noted and a noted item/technique may not necessarily yield the noted effect. Other capabilities may be provided and not every implementation according to the disclosure must provide any, let alone all, of the capabilities discussed.

### BRIEF DESCRIPTION OF THE DRAWINGS

FIG. 1A is a block diagram of an example of a system-on-chip (SoC) with controllers and peripherals.

FIG. 1B is a conceptual diagram of a software image in a standard executable and linkable format (ELF) image.

FIG. 2 is a packet flow diagram of an example prior art boot flow.

FIG. 3 is a packet flow diagram of an example boot flow with a grouped authentication process.

FIG. 4 is a packet flow diagram of an example secure boot flow utilizing lightweight hashing.

FIG. 5 is a flow diagram of an example method loading a pageable segment based in part on lightweight hash values.

FIG. 6 is a flow diagram of an example method loading pageable segment based in part on a batched authentication process.

### DETAILED DESCRIPTION

Techniques disclosed herein are configured to provide a secure boot sequence in a multiprocessor application. Many SoC chips sets used in Internet of Things (IoT) applications may be significantly limited in the available memory resources (e.g., RAM). The limited amount of RAM may create a constraint for loading code during a boot process. In an example, an IoT chip may communicate with another subsystem such as an applications processor (AP) and the IoT chip may load a boot image from the AP (e.g., via a primary boot loader (PBL) and a secondary boot loader (SBL)). The image may be loaded and executed from the available RAM. In many SoC chip sets a potential problem is that the image to be loaded can be larger than the available RAM. In this case, some of the code segments are loaded (i.e., resident/non-pageable segments) and remain in RAM while other code segments may be loaded on an as needed basis (i.e., pageable segments). For example, the resident code segments are initially loaded and then some of the pageable segments are subsequently loaded during runtime.

A WiFi chip (e.g., SoC) is an example of IoT device with a limited amount of RAM. The WiFi chip may communicate with another subsystem (e.g., an applications processor AP). The WiFi chip may be configured to load a software image from the AP and then execute the image from its own RAM. The software image may be loaded via a Peripheral Component Interconnect (PCI) interface. In this example, the software image to be loaded is larger than the available RAM in the WiFi chip set. In this case, some of the code segments are loaded (resident code segments which will stay in RAM all the time), and other pageable segments are loaded when needed.

In general, a code segment must be authenticated each time it is loaded from the AP to maintain the security of the system. The authentication may involve digital signal verification (e.g., RSA, Elliptic Curve Cryptography (ECC) and other such algorithms that are processor intensive or require additional hardware and implementation costs) and hashing (e.g., SHA, MD, Blake, etc.). Since the load-authenticate-use process may be repeated multiple times with paged segments at runtime, the power and performance of the SoC may be degraded when a full secure boot is enabled. The present disclosure improves existing secure boot mechanisms by reducing the repeated digital signature verification computations for pageable segments in a RAM constrained SoCs.

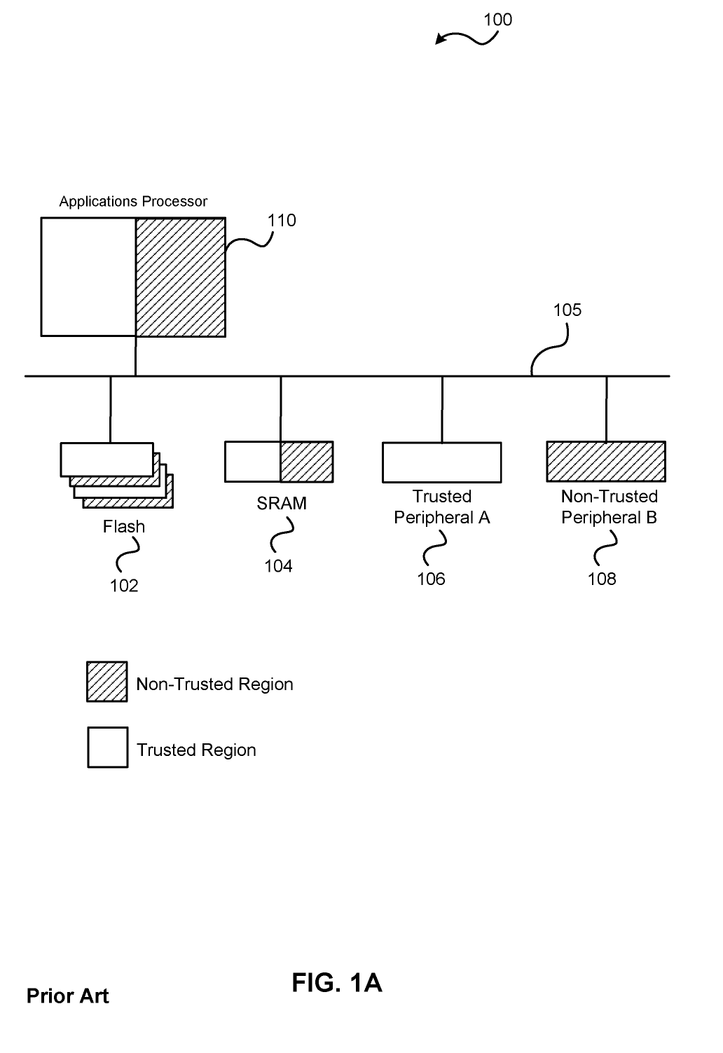

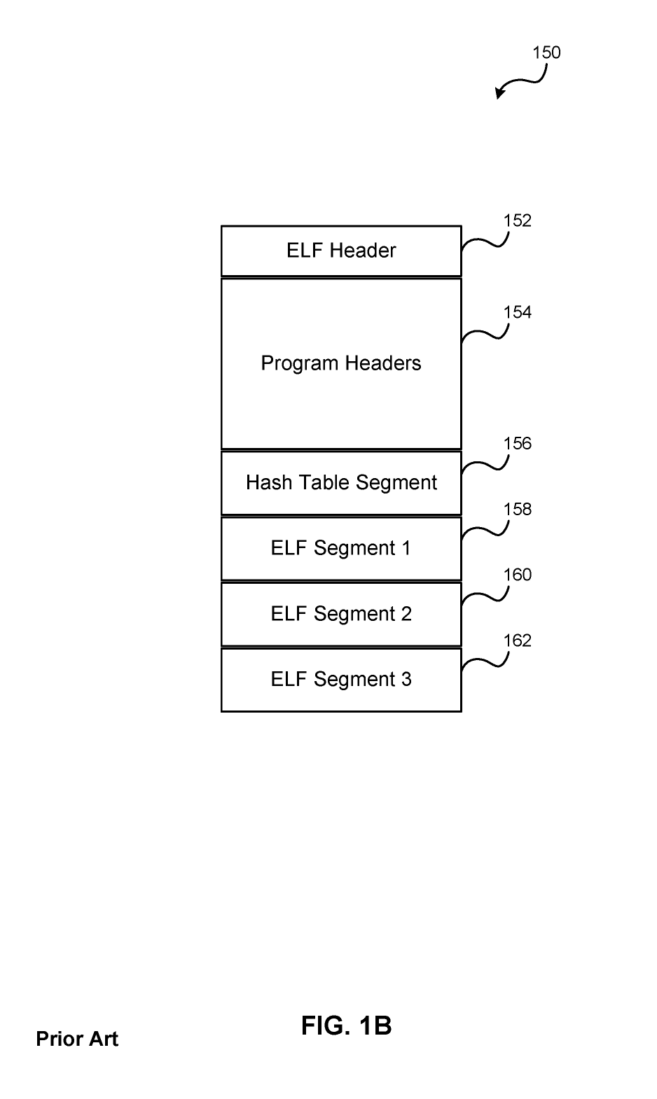

Referring to FIG. 1A, a block diagram of an example SoC 100 with controllers and peripherals. It should be noted that FIG. 1A is meant only to provide a generalized illustration of various components with an apparatus, any or all of which may be utilized as appropriate. FIG. 1A, therefore, broadly illustrates how individual system elements may be implemented in a relatively separated or relatively more integrated manner.

The SoC 100 is shown comprising hardware elements that can be electrically coupled via a bus 105 (or may otherwise be in communication, as appropriate). The hardware elements may include an application processor 110, including without limitation one or more general-purpose processors and/or one or more special-purpose processors and/or peripherals (such as digital signal processing chips, graphics acceleration processors, and/or the like). The application processor 110 may include a Trusted Execution Environment (TEE) such as the ARM TRUSTZONE technology which may be integrated into the application processor 110. The bus 105 may be the ARM AMBA 5 AHBS architecture. The SoC 100 may also interface one or more other devices such as flash memory 102, Static Random Access Memory (SRAM) 104, and one or more peripheral devices such as a trusted peripheral device A 106 and a non-trusted peripheral device B 108. The designations of trusted and non-trusted may be based on the ARM TRUSTZONE technology. In general, the peripheral devices may be SoC chips which enable high end functionality such as network access and communication devices (e.g., Wireless Local Area Network (WLAN), WiFi, WiGig, BLUETOOTH, Wireless Wide Area Network (WWAN), etc.

Instructions and/or code may be stored on a computer-readable storage medium, such as the flash memory 102, SRAM 104 or other memory within the peripheral devices. These instructions might take the form of executable code, which is executable by the SoC 100 and/or might take the form of source and/or installable code, which, upon compilation and/or installation on the SoC system 100 or the peripheral devices 106, 108 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

A peripheral device 106, 108 may receive instructions from the application processor 110 and/or the flash memory 102 to execute a secure boot sequence. Generally, a secure boot may be defined as a boot sequence in which each software image to be executed is authenticated by software that was previously verified. This sequence is designed to prevent unauthorized or modified code from being run. In an example, a first ROM bootloader may cryptographically verify the signature of the next bootloader in a chain, then that bootloader may cryptographically verify the signature of the next software image or images, and so on. The first piece of ROM-based software may be called a Primary BootLoader (PBL) and it typically loads and authenticates a Secondary BootLoader (SBL) or eXtensible BootLoader (XBL) as the next image to be run. This image may then be configured to load and authenticates a feature-rich applications bootloader such as Little Kernel (LK) or the Unified Extensible Firmware Interface (UEFI) that is specific to the Operating System (OS) that it will subsequently load. These software images may exist as standard Executable and Linkable Format (ELF) images.

Like most digitally signed software, these image signatures may include a certificate chain. An Attestation certificate may refer to the lowest level certificate authorizing the signature of the software image. This certificate may be signed by an Attestation CA certificate which is in turn may be signed by a Root CA certificate. The Root CA certificate may be validated by computing its hash and comparing to a value stored either in an eFuse or in ROM (i.e., eFuse may be a set of hardware embedded one-time programmable bits that once “blown” cannot be reverted). This stored Root CA hash value may be provisioned to the device by an Original Equipment Manufacturer (OEM), and may be configured to provide full control of the device's cryptographic root of trust.

Referring to FIG. 1B, a conceptual diagram of a software image in an ELF image 150 is shown. The ELF image 150 may include an ELF header 152, program headers 154, a hash table segment 156, a first ELF segment, 158, a second ELF segment 160, and third ELF segment 162. Additional segments may be included in the image 150. The ELF image 150 may represent resident and pageable segments. The ELF header 152 may include values to define the target environment such as machine, class and data identification (e.g., based on little or big endian targets). The program headers 154 may include values to tell the system how to create a process image (e.g., flags, offsets, virtual addresses, physical address, sizes, etc.). The hash table segment 156 typically follows the ELF and Program headers in the image. It may include a 40-byte header which specifies the size of the entire hash segment, the size of the table of hashes, the size of the attestation signature, and the size of the certificate chain (all in bytes). In an example, the hash table may contain the SHA-256 digest of each segment in the ELF image, as well as a digest for the ELF and Program headers.

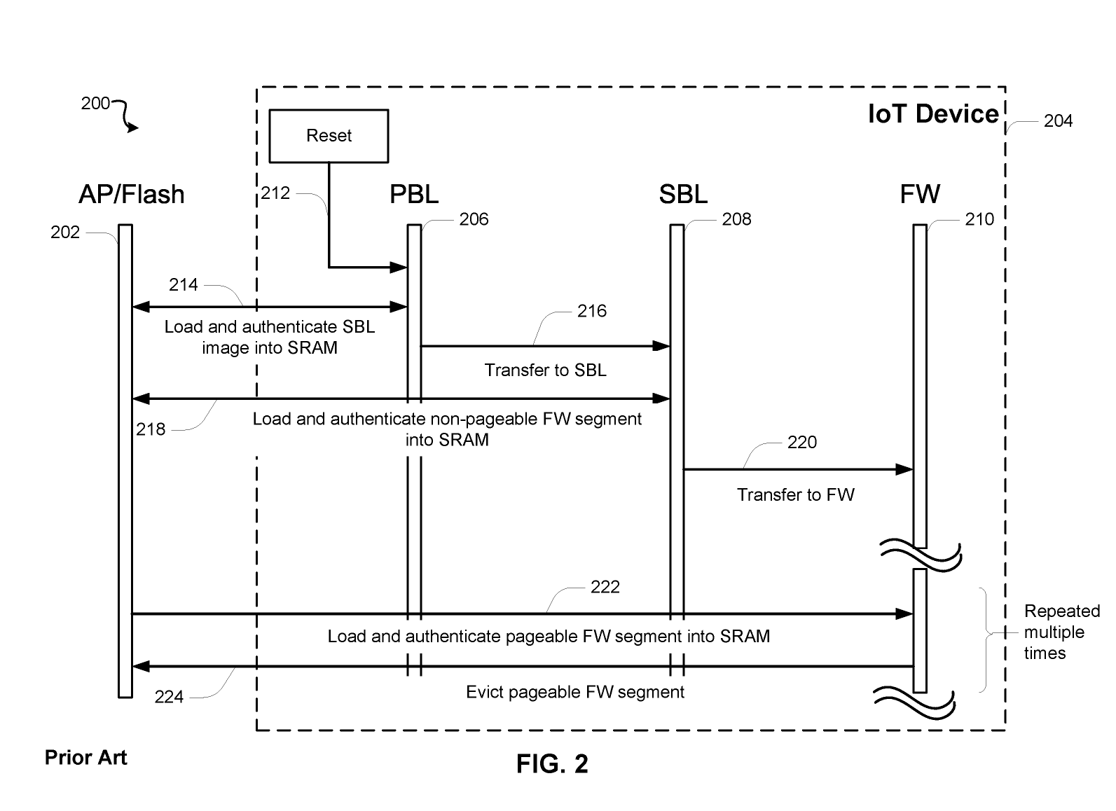

Referring to FIG. 2, a packet flow of an example prior art boot flow 200 is shown. The boot flow 200 may include loading one or more ELF images 150 from an application processor (and/or associated flash memory) 202 to an Internet of Things (IoT) device 204. For example, referring to FIG. 1A, the application processor 110 and/or flash memory 102 may provide instructions to the non-trusted peripheral device 108 via the bus 105. The IoT device 204 is configured to perform the functions associated with a Primary Boot Loader (PBL) 206, a Secondary Boot Loader (SBL) 208, and the instructions loaded into a Firmware Image (FW) 210. The FW instructions may include both non-pageable and pageable FW segments. A reset or initialization signal 212 is configured to trigger the start of the boot flow 200 and the PBL 206 begins executing. The PBL 206 is configured to perform a Secondary Boot Loader (SBL) load process 214. The SBL load process 214 includes loading and authenticating the SBL code segments from the AP/Flash 202. The PBL 206 is configured to perform a SBL transfer process 216 to provide the authenticated SBL code segments to the SBL 208. The SBL 208 is configured to perform a resident FW segment load process 218 to load and authenticate the resident (i.e., non-pageable) FW segment from the AP/Flash 202. The authentication may be based on ELF hash segments contained in the loaded FW segment. The SBL 208 is configured to execute a transfer process 220 to load the authenticated non-pageable FW segment into the FW image 210 (e.g., local RAM in the IoT device 204).

The FW starts executing based on the transferred non-pageable FW segment and may then execute a pageable segment loading and authentication process 222. If the AP/Flash 202 is an untrusted entity, a pageable FW segment must be authenticated every time it is loaded. The additional hashing and computations required for the authentication may negatively impact the load time and performance of the IoT device 204. Additionally, since the IoT device has a limited amount of RAM, the FW image 210 may include code for a pageable FW segment eviction process 224 to make memory available of other pageable FW segments. These other pageable FW segments will be loaded and authenticated via the process 222 and potentially evicted at process 224. It is possible for a pageable FW segment to be loaded, authenticated, and evicted multiple times during a boot sequence. The computation load to authentication a pageable FW segment each time it is loaded can increase the time required to load and increase the power consumption of the IoT device 204.

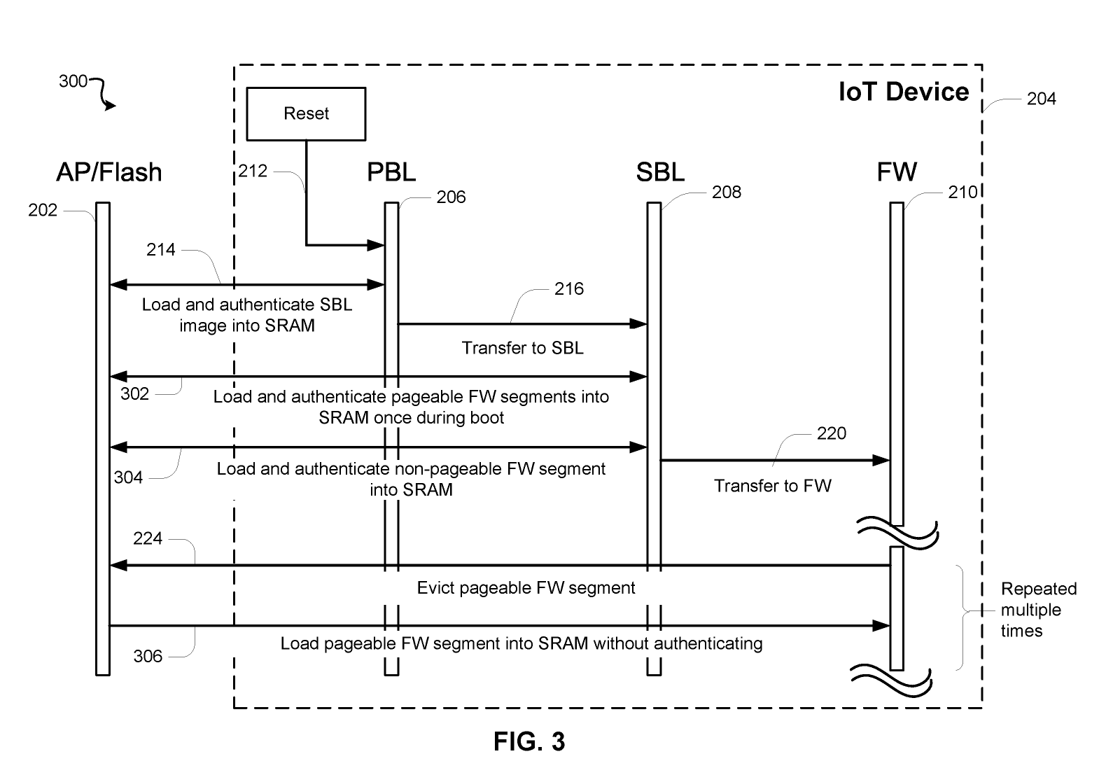

Referring to FIG. 3, with further reference to FIG. 2, a packet flow diagram of an example boot flow with a grouped authentication process 300 is shown. The grouped authentication process 300 may provide for an improvement over the prior art boot flow 200 by performing only a single authentication process on each pageable FW segment. The subsequent loading(s) of the pageable FW segments occur(s) without performing an authentication process. For example, as previously described, the IoT device 204 is configured to perform the functions associated with the PBL 206, the SBL 208, and the instructions loaded into the FW image 210. The reset or initialization signal 212 triggers the start of the boot flow within the grouped authentication process 300 and the PBL 206 begins executing. The PBL 206 performs the SBL load process 214, including loading and authenticating the SBL code segments from the AP/Flash 202. The PBL 206 performs the SBL transfer process 216 to provide the authenticated SBL code segments to the SBL 208. The SBL 208 is configured to load and authenticate both pageable and non-pageable FW segments in a respective pageable FW segment load and authentication process 302, and a non-pageable FW segment load and authenticate process 304. The authentication may also be based on ELF hash segments contained in the pageable and non-pageable FW segments, however as compared to the prior art boot flow 200, the pageable FW segments are only authenticated once. The single authentication reduces the computation load as compared to the prior art boot flow 200. The SBL 208 is configured to execute a transfer process 220 to load the authenticated non-pageable FW segments into the FW image 210. The pageable FW segments are evicted via the eviction process 224, and then loaded as required via a load pageable FW segments process 306. The process 306 does not repeat the authentication process. That is, an assumption is made that the pageable FW segments have not been corrupted in the intervening time between the pageable FW segment load and authentication process 302, and the load pageable FW segments process 306. This assumption, however, may provide a potential security risk as compared with the prior art boot flow 200. For some applications, the performance improvements provided by the grouped authentication process 300 may not outweigh the potential security risks.

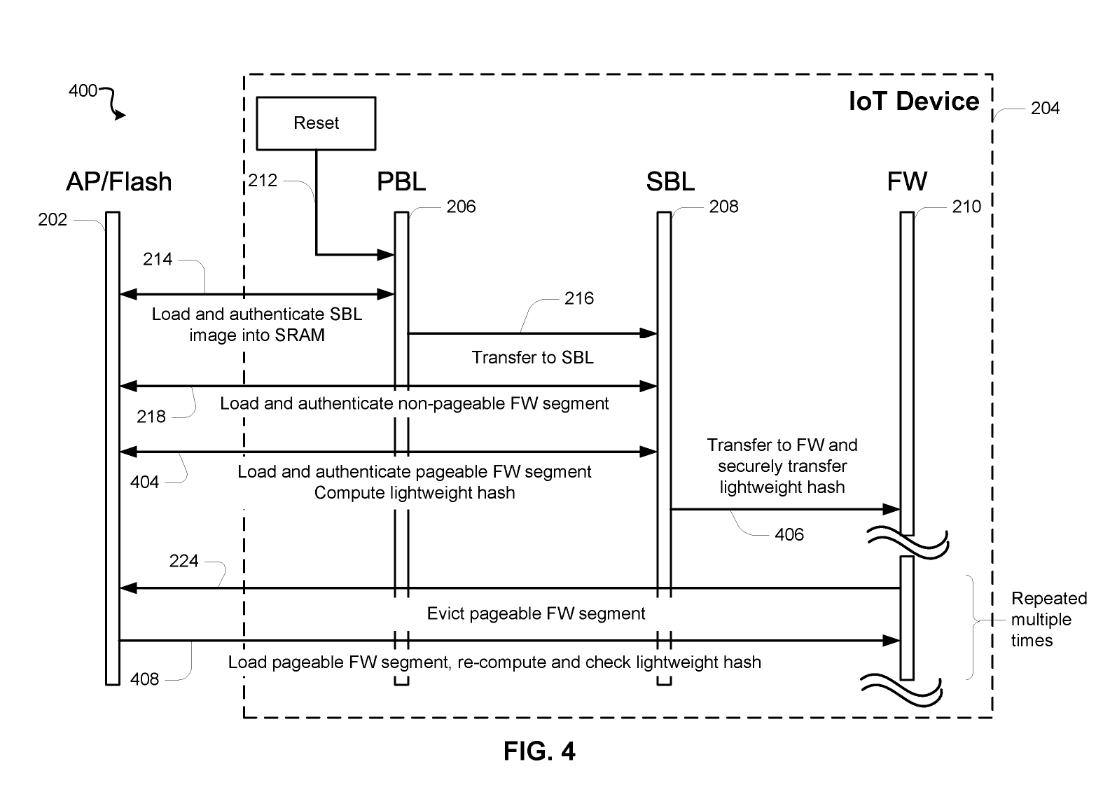

Referring to FIG. 4, with further reference to FIGS. 2 and 3, a packet flow diagram of an example secure boot flow 400 utilizing lightweight hashing is shown. The secure boot flow 400 performs a group authentication of the pageable FW segments with the addition of computing a lightweight hash for the segments. The lightweight hashes may be efficiently computed within a processing circuit (e.g., a hardware copy engine circuit), or they may be computed via software algorithm. Examples of lightweight hashing may include Toeplitz, QUARK, PHOTON, SPONGENT, or other bit/register shifting algorithms which may be executed with fewer processor cycles as compared to heavier hashing algorithms (e.g., SHA, MD5, etc.). An example of pseudocode for computing a Toeplitz hash may include the following operations:

ComputeHash(input[ ], n)

result = 0

For each bit b in input[ ] from left to right
{

if (b == 1) result \hat{ }= (left-most 32 bits of K)
shift K left 1 bit position

}

return result

The lightweight hash size may be variable based on the size of the pageable FW segments. The processing overhead required for computing a lightweight hash is typically significantly lower as compared to other cryptographic hashing algorithms. In an example, a random key may be used to calculate a lightweight hash. The addition of the random key increases the level of security for data transferred from the AP/Flash 202.

In operation, as previously described, the IoT device 204 is configured to perform the functions associated with the PBL 206, the SBL 208, and the instructions loaded into the FW image 210. The reset or initialization signal 212 triggers the start of the secure boot flow 400 and the PBL 206 begins executing. The PBL 206 performs the SBL load process 214, including loading and authenticating the SBL code segments from the AP/Flash 202. The PBL 206 performs the SBL transfer process 216 to provide the authenticated SBL code segments to the SBL 208. The SBL 208 is configured to perform a resident FW segment load process 218 to load and authenticate the resident (i.e., non-pageable) FW segment from the AP/Flash 202. The authentication may be based on ELF hash segments contained in the loaded FW segment. The SBL 208 is also configured to load and authenticate the pageable FW segments and compute the lightweight hash for the pageable FW segments via an authentication and lightweight hashing process 404. The authentication may be based on the ELF hash segments and lightweight hash values may be computed based on hardware within the SoC 100, the IoT device 204, or on a software algorithm operating within the SBL 208. The SBL 208 is configured to transfer the non-pageable FW segments and the lightweight hash information to the FW 210 in a hash transfer process 406. For example, the SBL 208 may be configured to store the non-pageable FW segments and the lightweight hash information in the RAM of the IoT device 204. The pageable FW segments may be discarded by the SBL 208 after they are authenticated and the corresponding lightweight hash values are computed and stored. The FW 210 may be configured to subsequently load a pageable FW segment. A pageable FW segment load and verification process 408 may be used to load and re-compute the lightweight hash for a pageable FW segment. The re-computed lightweight hash value may then be compared to the previously stored lightweight hash value for the segment to validate the segment. If the lightweight hashes are the same, then the load and FW execution may continue. A mismatch between the lightweight hashes may be an indication of a security breach and may be the basis for a fatal interrupt within the FW execution. The lightweight hashing of the pageable FW segments provides an increased level of security as compared to the grouped authentication process 300 (i.e., where the pageable FW segments are not authenticated after an initial authentication), without all of the processing overhead required by the prior art boot flow 200 (i.e., where the pageable FW segments are authenticated every time they are loaded). The lightweight hashing of the pageable FW segments enables a more efficient and secure boot load process.

In an embodiment, the IoT device may be configured to compute and save lightweight hashes for all pageable FW segments at cold boot time and save that hash information for later use during re-loading of pageable FW segments. The lightweight hash operation may be performed with an efficient hash algorithm which is implemented in hardware or software. The secure boot flow 400 may allow for secure loading of pageable FW segments from an AP with a reduced impact on system performance. The secure boot flow 400 may be implemented for flash boot (e.g., when the segments are read from a flash memory) or flashless (e.g., when the segments are received from the AP side using a flashless protocol). A secure boot flow 400 may be implemented in a demand paging mechanism (e.g., paging out segment and paging in a new one) such that it is transparent to the kernel and user space. The secure boot flow 400 may be implemented in a wake-up from deep sleep use case, such that the full image may be loaded again. This wake-up use case typically requires the execution of a full authentication process (e.g., including RSA/ECC) which may require significant processing/load time costs. The secure boot flow 400 does not require another full authentication since the lightweight hash values of the segments are preserved in memory. The segments may be validated based on re-computing and comparing the lightweight hash values when the segments are loaded (i.e., the pageable FW segment load and verification process 408).

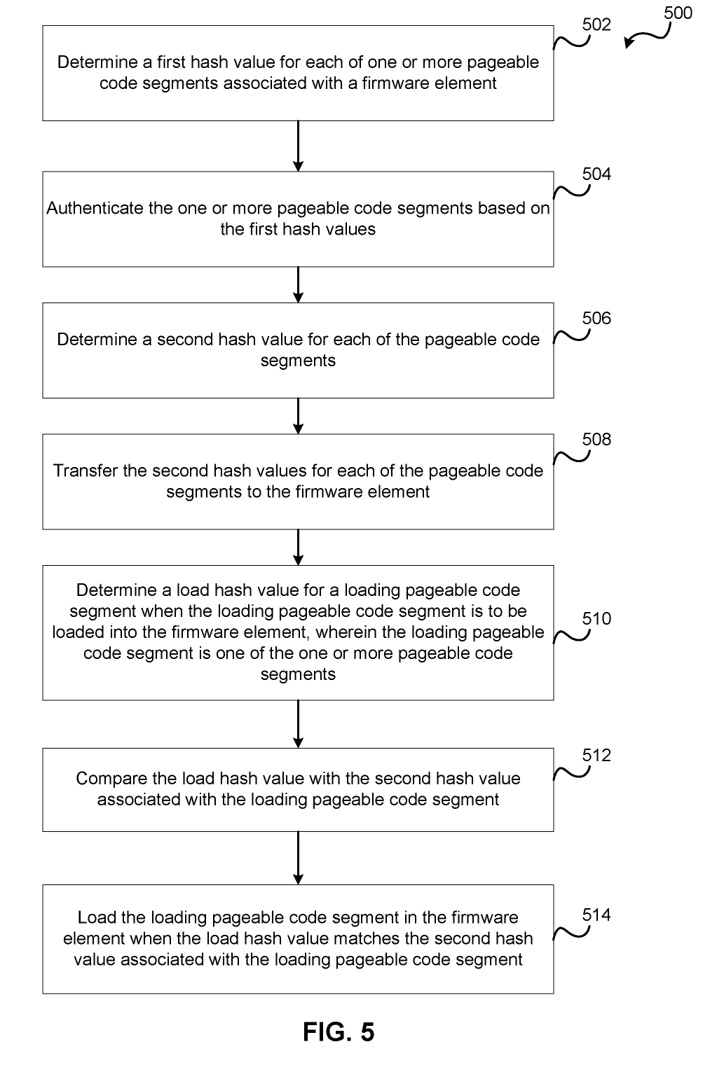

Referring to FIG. 5, a method 500 for loading a pageable segment based in part lightweight hash values includes the stages shown. The method 500 is, however, an example only and not limiting. The method 500 can be altered, e.g., by having stages added, removed, rearranged, combined, performed concurrently and/or having stages split into multiple stages. The method 500 may be included in a boot sequence in a multiprocessor system.

At stage 502 the method includes determining a first hash value for each of one or more pageable segments associated with a firmware element. The firmware element may be an IoT device 204. Typically, an IoT device may include standalone chips configured to boot independently, or they may be pared with an application processor (AP) as a separate secondary chip over flashless interconnects. The chips within an IoT device may be integrated within an AP SoC to provide higher end functions (e.g., WLAN, WiFi, WiGig, BLE, WWAN, etc.). The code segments may persist as ELF images within a memory device such as a flash memory 102 or SRAM 104. The first hash values may correspond to the values in the hash table segment 156 which may be based on processor intensive hashing algorithms such as SHA, MD, Blake, etc. The first hash values are utilized by the SBL to authenticate the pageable segments.

At stage 504 the method includes authenticating the one or more pageable segments based on the first hash values. In an example, an ELF image may be authenticated by computing the first hash and comparing the computed first hash to a previously stored value (e.g., the hash table segment 156). Referring to FIG. 4, the SBL 208 may be configured to load and authenticate one or more pageable segments via the authentication and lightweight hashing process 404. The SBL 208 executing on the IoT device 204 may be a means for authenticating one or more pageable segments.

At stage 506, the method includes determining a second hash value for each of the pageable segments. The second hash values are lightweight hash values which may be calculated with relatively less processing overhead as compared to the first hash values. For example, a lightweight hash values may be Toeplitz hash values computed via a hardware element such as a copy engine integrated in a peripheral component interconnect express (PCI-e) interface. If the pageable segments reside in a flash memory, the Toeplitz hash values may be computed via a software algorithm executing on the AP or with in the firmware element (e.g., a peripheral device). The lightweight hash may be implemented via one or more register shifting operations as known in the art. Other hashing hardware and software processes may also be used. The SBL 208 may be configured to determine a second hash value for each of the pageable FW segments via the authentication and lightweight hashing process 404. In an example, a copy engine in the AP or the SBL 208 executing on the IoT device 204 may be means for determining the second hash values.

At stage 508, the method includes transferring the second hash values for each of the pageable segments to the firmware element. The second hash values may be transferred to the firmware element by storing the values in a memory that is accessible to the firmware element. For example, the SBL 208 may be configured to store the second hash values in RAM on the IoT device 204 via the hash transfer process 406. The SBL 208 executing on the IoT device 204 may be a means for transferring the second hash values.

At stage 510, the method includes determining a load hash value for a loading pageable segment when the loading pageable segment is to be loaded into the firmware element, wherein the loading pageable segment is one of the one or more pageable segments. Referring to FIG. 4, the firmware element FW 210 is configured to evict and load pageable FW segments from the AP/Flash 202 on an as needed basis. The pageable FW segment load and verification process 408 may be used to load and re-compute the second hash value for a pageable FW segment. The loading pageable segment is the pageable FW segment being loaded from the AP/Flash 202 and the load hash value is the re-computed second hash value determined at the time the FW loads the pageable FW segment. The lightweight hash value for the loading pageable segment may be computed using the hashing process described at stage 504. For example, a copy engine in the AP or the FW image 210 executing on the IoT device 204 may be means for determining the load hash value.

At stage 512, the method includes comparing the load hash value with the second hash value associated with the loading pageable segment. Referring to FIG. 4, the firmware element FW 210 is configured to load pageable FW segments from the AP/Flash 202 on an as needed basis. The pageable FW segment load and verification process 408 may be used to re-compute second hash value for the loading a pageable FW segment. The re-computed second hash value may then be compared to the second hash value for the same segment transferred at stage 506 to validate the segment. A string compare function (e.g., strcmp), or other similar operations may be used to compare the load hash value (i.e., the re-computed second hash value) with the second hash value (i.e., the hash value computed at stage 506). The FW 210 executing on the IoT device 204 may be means for comparing the hash values.

At stage 514, the method includes loading the loading pageable segment when the load hash value matches the second hash value associated with the loading pageable segment. The pageable FW segment load and verification process 408 may be used to load the loading pageable segment when the load hash value (i.e., the re-computed lightweight hash for loading pageable segment) matches the second hash value previously computed for the same pageable segment via the authentication and lightweight hashing process 404. If the lightweight hashes are the same, then the load and FW execution may continue. A mismatch between the loading hash and the originally computed lightweight hash (i.e., the second hash value associated with the loading pageable segment) may be an indication of a security breach and may be the basis for a fatal interrupt with the FW execution.

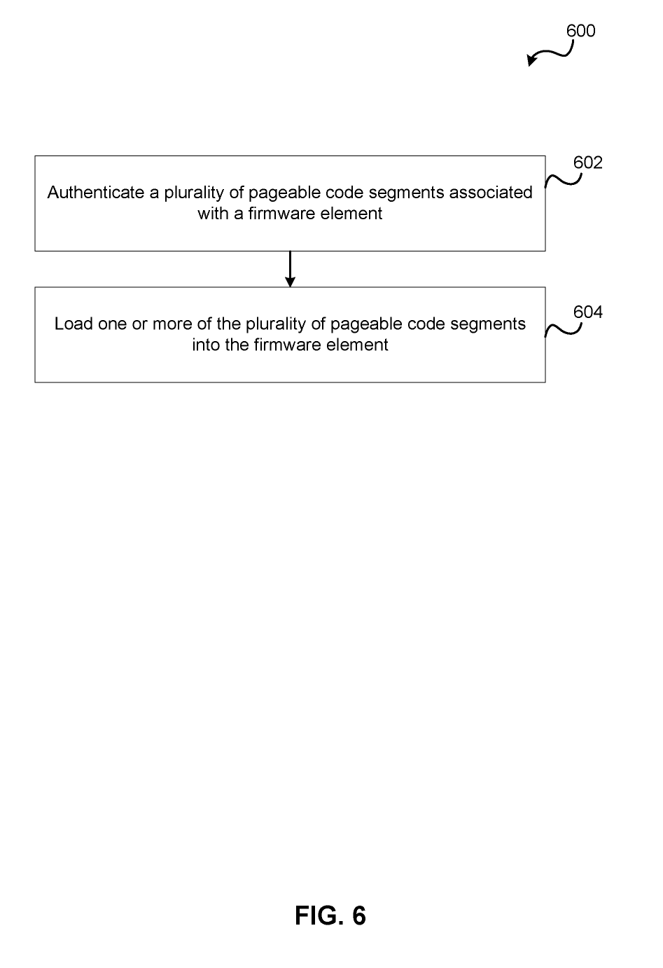

Referring to FIG. 6, with further reference to FIG. 3, a method 600 for loading pageable segments based in part on a batched authentication process is shown. The method 600 is, however, an example only and not limiting. The method 600 can be altered, e.g., by having stages added, removed, rearranged, combined, performed concurrently and/or having stages split into multiple stages.

At stage 602, the method includes authenticating a plurality of pageable segments associated with a firmware element. In an example, the SBL 208 is configured to load and authenticate pageable segments from the AP/Flash 202 via the pageable segment load and authentication process 302. The authentication may be based on ELF hash segments contained in the pageable segments. Once the pageable segments are authenticated, the SBL 208 may be configured to evict them for subsequent loading by the FW 210.

At stage 604, the method includes loading one or more of the plurality of pageable segments into the firmware element. In an example, the FW 210 is configured to load a pageable segment from the AP/Flash 202 via the load pageable FW segments process 306. Since the pageable segments were authenticated at stage 602, the authentication process is not repeated during the load. The pageable segment may be evicted from memory on the firmware element and subsequent reloaded without authentication.

The IoT device 204 may be a SoC, or some elements of the IoT device may be deployed as peripherals on the SoC 100 to perform methods in accordance with various embodiments described herein. The terms “machine-readable medium”, “computer-readable medium,” “segment” and “code segment” as used herein, refer to any medium that participates in providing data or portions of data that causes a machine to operate in a specific fashion. In an embodiment implemented using the SoC 100 and/or the IoT device 204, various computer-readable media might be involved in providing instructions/code to the application processor 110 for execution and/or might be used to store and/or carry such instructions/code (e.g., as signals). The flash 102 and SRAM 104 may be a non-transitory processor-readable storage medium comprising processor-readable instructions configured to cause a processor controlled device to perform the boot flows as secure boot flow 400. In many implementations, a computer-readable medium is a physical and/or tangible storage medium. Such a medium may take many forms, including but not limited to, non-volatile media, volatile media, and transmission media.

Common forms of physical and/or tangible computer-readable media include, for example, a RAM, a PROM, EPROM, a FLASH-EPROM, eMMC, any other memory chip or cartridge, a or any other medium from which a computer can read instructions and/or code.

Various forms of computer-readable media may be involved in carrying one or more sequences of one or more instructions to SoC 100 and/or the IoT device 204 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the SoC 100. These signals, which might be in the form of electromagnetic signals, acoustic signals, optical signals and/or the like, are all examples of carrier waves on which instructions can be encoded, in accordance with various embodiments of the invention.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for loading pageable segments in a device, comprising:
determining a first hash value for each of one or more pageable segments associated with the device;
authenticating the one or more pageable segments based on the first hash values;
determining a second hash value for each of the one or more pageable segments;
transferring the second hash values for each of the one or more pageable segments to the device;
determining a load hash value for a loading pageable segment when the loading pageable segment is to be loaded into the device, wherein the loading pageable segment is one of the one or more pageable segments;
comparing the load hash value with the second hash value associated with the loading pageable segment; and
loading the loading pageable segment in the device when the load hash value matches the second hash value associated with the loading pageable segment.

2. The method of claim 1 wherein the second hash value and the load hash value are lightweight hash values.

3. The method of claim 1 wherein the second hash value and the load hash value are Toeplitz hash values.

4. The method of claim 1 wherein the second hash value and the load hash value are determined by a software algorithm.

5. The method of claim 1 wherein the second hash value and the load hash value are determined by a hardware element.

6. The method of claim 1 wherein the one or more pageable segments are in an executable and linkable format (ELF).

7. The method of claim 1 wherein the first hash values for the one or more pageable segments are based on an Elliptic Curve Cryptography (ECC) algorithm.

8. The method of claim 1 wherein transferring the second hash values for each of the one or more pageable segments to the device includes storing the second hash values in a memory device disposed on the device.

9. The method of claim 1 wherein a random key is used to compute the second hash value and the load hash value.

10. The method of claim 1 wherein the one or more pageable segments persist in a flash memory device.

11. A device, comprising:
a memory;
at least one processor operable coupled to the memory and configured to:
determine a first hash value for each of one or more pageable segments associated with the device;
authenticate the one or more pageable segments based on the first hash values;
determine a second hash value for each of the one or more pageable segments;
store the second hash values for each of the one or more pageable segments in the memory;
determine a load hash value for a loading pageable segment when the loading pageable segment is to be loaded into the device, wherein the loading pageable segment is one of the one or more pageable segments;
compare the load hash value with the second hash value associated with the loading pageable segment; and
load the loading pageable segment when the load hash value matches the second hash value associated with the loading pageable segment.

12. The device of claim 11 wherein the at least one processor is operably coupled to an application processor.

13. The device of claim 12 wherein the one or more pageable segments are received from the application processor.

14. The device of claim 11 wherein the at least one processor is operably coupled to a flash memory device.

15. The device of claim 14 wherein the one or more pageable segments are received from the flash memory device.

16. The device of claim 11 wherein the one or more pageable segments are in an executable and linkable format (ELF).

17. The device of claim 11 wherein the at least one processor is configured to the first hash values for each of the one or more pageable segments based on an Elliptic Curve Cryptography (ECC) algorithm.

18. The device of claim 11 wherein the at least one processor is configured to determine a random key and the second hash value and the load hash value are based at least in part on the random key.

19. The device of claim 11 wherein the second hash value and the load hash value are lightweight hash values.

20. The device of claim 11 wherein the second hash value and the load hash value are Toeplitz hash values.

21. A device, comprising:
means for determining a first hash value for each of one or more pageable segments associated with the device;
means for authenticating the one or more pageable segments based on the first hash values;
means for determining a second hash value for each of the one or more pageable segments;
means for transferring the second hash values for each of the pageable segments to the device;
means for determining a load hash value for a loading pageable segment when the loading pageable segment is to be loaded into the device, wherein the loading pageable segment is one of the one or more pageable segments;
means for comparing the load hash value with the second hash value associated with the loading pageable segment; and
means for loading the loading pageable segment in the device when the load hash value matches the second hash value associated with the loading pageable segment.

22. The device of claim 21 wherein the second hash value and the load hash value are lightweight hash values.

23. The device of claim 21 wherein the second hash value and the load hash value are Toeplitz hash values.

24. The device of claim 21 wherein the pageable segments are in an executable and linkable format (ELF).

25. The device of claim 21 wherein the means transferring the second hash values for each of the pageable segments to the device includes means for storing the second hash values in a memory device.

26. A non-transitory processor-readable storage medium comprising processor-readable instructions configured to cause one or more processors to load pageable segments in a device, comprising:
code for determining a first hash value for each of one or more pageable segments associated with the device;
code for authenticating the one or more pageable segments based on the first hash values;
code for determining a second hash value for each of the one or more pageable segments;
code for transferring the second hash values for each of the pageable segments to the device;
code for determining a load hash value for a loading pageable segment when the loading pageable segment is to be loaded into the device, wherein the loading pageable segment is one of the one or more pageable segments;
code for comparing the load hash value with the second hash value associated with the loading pageable segment; and
code for loading the loading pageable segment in the device when the load hash value matches the second hash value associated with the loading pageable segment.

27. The storage medium of claim 26 wherein the second hash value and the load hash value are lightweight hash values.

28. The storage medium of claim 26 wherein the second hash value and the load hash value are Toeplitz hash values.

29. The storage medium of claim 26 wherein the first hash values for the one or more pageable segments are based on an Elliptic Curve Cryptography (ECC) algorithm.

30. The storage medium of claim 26 further comprising code for storing the one or more pageable segments in a flash memory device.
